(19) United States
(12) Patent Application Publication
(10) Pub. No.: US 2005/0253313 A1
(43) Pub. Date: Nov. 17, 2005

(54) Heat treating silicon carbide articles

(75) Inventor: Abuagela H. Rashed, Denton, TX (US)

Correspondence Address: BRACEWELL & GIULIANI LLP, P.O. BOX 61389, HOUSTON, TX, 77208-1389, US

(73) Assignee: Poco Graphite, Inc.

(21) Appl. No.: 10/846,025

(22) Filed: May 14, 2004

(51) Int. Cl. C04B 41/91

(52) U.S. Cl. 264/646; 264/648; 264/674; 264/682; 65/412

(57) ABSTRACT

A process for heat-treating a silicon carbide article to remove residual amounts of free carbon and graphite is provided. The process includes supplying a silicon carbide article and heating the silicon carbide article within a predetermined temperature range for a predetermined time period. The heating is performed in the presence of an oxidizing agent. As a result, gaseous products, such as carbon dioxide and carbon monoxide, are liberated containing byproducts formed by oxidizing free carbon and graphite to remove the residual free carbon and graphite. Gases are produced as a result of the heating of the silicon carbide article. Particles are removed from the silicon carbide article without forming an oxide layer upon the silicon carbide article. As a result, the silicon carbide article is substantially free of carbon and graphite inclusions.

### TECHNICAL FIELD OF THE INVENTION

The present invention relates to a method of heat-treating silicon carbide articles and the resulting substantially particle-free silicon carbide article.

### BACKGROUND OF THE INVENTION

Silicon carbide is used in a wide variety of applications, such as in the production of semiconductors; as a mirror substrate for high energy lasers, laser radar systems, surveillance, telescopes, scan mirrors, and satellites; as an optical bench; as dummy and baffle wafers; and as etch chamber components, such as electrodes, focus rings and shower heads. When a silicon carbide article is formed, residual free carbon and graphite particles from the raw materials used to form the silicon carbide article are not converted to silicon carbide and remain adhered to or abuttingly contact the finished silicon carbide article. As a result, the residual particles can cause contamination issues when the silicon carbide article is used in subsequent processes, such as in the applications described herein and particularly plasma etching processes.

Others have attempted to remove such residual particle contaminants using a variety of mechanisms. For example, U.S. Pat. No. 5,051,134 issued to Schnegg, et al., U.S. Pat. No. 5,665,168 issued to Nakano, et al., U.S. Pat. No. 5,837,662 issued to Chai, et al., and U.S. Pat. No. 5,712,198 issued to Shive, et al. describe processes for cleaning silicon wafers to suppress and reduce the amount of particles that adhere to the silicon wafers. The processes described in these patents primarily rely upon using various chemical solutions, such as acidic solutions, to chemically clean the silicon wafers. The use of the chemical cleaning solutions to clean the silicon wafers are expensive and create hazardous waste that must be discarded.

U.S. Pat. No. 6,506,254 issued to Bosch et al. describes a process for removing particles on semiconductor substrates, such as silicon carbide articles, by subjecting a substrate to a heat treatment in an air environment that produces an oxide layer upon the substrate that encapsulates the particles in the oxide layer and/or converts the particles to an oxide, which then forms a part of the oxide layer. The oxide layer is formed by heating the substrate within a furnace at 1200° C. to 1700° C. for 1 to 100 hours. The oxide layer containing the particles must then be removed by either an acid bath or a chemical etching treatment.

A need exists for an effective process of removing particles, particularly residual carbon and graphite, from silicon carbide articles without the expense and inherent danger of extraneous chemical cleaning. A need also exists for a process of removing particles from silicon carbide articles that results in a stoichiometric high-purity silicon carbide article that is ready for subsequent plasma etching processing without the need to further clean the article.

### SUMMARY OF THE INVENTION

In view of the foregoing, the present invention advantageously provides a process for heat-treating a silicon carbide article to remove residual amounts of free carbon and graphite. The process includes supplying a silicon carbide article and heating the silicon carbide article within a predetermined temperature range for a predetermined time period. Preferably, the silicon carbide article is heated at atmospheric pressure. The silicon carbide article can include but is not limited to converted silicon carbide, reaction-bonded silicon carbide, reaction-formed silicon carbide, chemical-vapor-deposited silicon carbide, and silicon carbide fiber-reinforced silicon carbide matrix composites.

The predetermined temperature range is preferably in a range of about 600° C. to about 1000° C., and more preferably from about 700° C. to about 900° C. The temperature is controlled to avoid exceeding the predetermined temperature range. In this temperature range, the silicon carbide article is exposed to a combination of both radiation and conduction, with radiation being the major heat transfer means. The predetermined time period is dependent on the size of the article to be heat-treated and number of parts. For example, an eight inch diameter, ¼″ thick part can be heated for a time period in a range of about one hour for one part and up to six hours for six parts. The heating is performed in the presence of an oxidizing agent. The oxidizing agent is preferably a gas mixture containing oxygen. The oxidizing agent is more preferably selected from the group consisting of air, oxygen, an oxygen-nitrogen gas mixture, an oxygen-argon gas mixture, an oxygen-helium gas mixture, and combinations thereof.

The oxidizing agent can be supplied at various flowrates, depending upon the size of the furnace used to heat treat the silicon carbide articles. For example, a smaller furnace, such as a 1 ft3 furnace, can require a flow rate of about 1 scfh to about 10 scfh. A larger furnace, such as a 4 ft3 furnace, can require a flow rate of about 5 scfh to about 40 scfh. A suitable flow rate for the oxidizing agent will be known to those of ordinary skill in the art of furnaces and is to be considered within the scope of the present invention.

As a result of the step of heating the silicon carbide article, gaseous products, such as carbon dioxide and carbon monoxide, are liberated containing byproducts formed by oxidizing the free carbon and graphite thereby removing the residual free carbon and graphite from the silicon carbide article. Gases are produced as a result of the heating of the silicon carbide article. As opposed to some prior art oxidation methods, particles are removed from the silicon carbide article without forming an oxide layer upon the silicon carbide article. As a result, the silicon carbide article is substantially free of carbon and graphite inclusions and ready for further processing without the need for further cleaning.

In addition to the processes of heat treating a silicon carbide article, the present invention also advantageously includes a silicon carbide article that is substantially free of carbon and graphite inclusions without an outer oxide layer abuttingly contacting and substantially surrounding the silicon carbide article and that is suitable for use in plasma etching.

### DETAILED DESCRIPTION OF THE INVENTION

The present invention advantageously provides a process for the heat treatment of silicon carbide articles to improve their performance in subsequent processes or applications, such as plasma etching. The present invention advantageously provides a heat treatment process developed for the removal of any residual free carbon and/or graphite from silicon carbide articles. The presence of such free carbon and/or graphite in the silicon carbon articles has been shown to cause a particulate generation problem in the plasma etching processes.

Carbon and/or graphite are used as precursors for the fabrication of silicon carbide articles. Accordingly, the produced silicon carbide articles can contain some residual amounts of such carbon and/or graphite that did not fully convert to silicon carbide during the silicon carbide production process. These residual amounts of free carbon and/or graphite can be imbedded within the body of the silicon carbide article and/or within the silicon carbide grains comprising the silicon carbide article. The silicon carbide articles can include but are not limited to converted silicon carbide, reaction-bonded silicon carbide, reaction-formed silicon carbide, chemical-vapor-deposited silicon carbide, and silicon carbide fiber-reinforced silicon carbide matrix composites. The residual amounts of free carbon and/or graphite are removed from such silicon carbide articles using the heat treatment processes described herein.

The present invention advantageously provides a process for heat-treating a silicon carbide article to remove residual amounts of free carbon and graphite from the silicon carbide article. The process for heat-treating the silicon carbide articles includes supplying a silicon carbide article having residual free carbon and graphite abuttingly contacting or adhered to the silicon carbide article. The silicon carbide article is then heated within a predetermined temperature range for a predetermined time period in the presence of an oxidizing agent.

The silicon carbide article is preferably heated at atmospheric pressure. The methods described herein can be performed using a vacuum or under pressure. Operating the process under a vacuum, however, could enhance the oxidation of silicon carbide, which is to be avoided. High pressure could be useful to stop or slow down the oxidation of the silicon carbide. Using a vacuum or high pressure requires the use of expense equipment. Furnaces that are designed to operate at high pressures or under vacuum conditions are generally more expensive to design and manufacture. Instead of trying to manipulate the pressures to control oxidation of silicon carbide, controlling the temperature range to control oxidation is preferred.

During the heating step of the process, gaseous products are liberated that contain byproducts that are formed as a result of oxidizing the residual free carbon and graphite that abuttingly contacts or is adhered to the silicon carbide article. The residual free carbon and graphite are thereby removed from the silicon carbide article without the formation of an oxide layer upon the silicon carbide article. The silicon carbide article is substantially free of carbon and graphite inclusions as a result of the process.

In all embodiments of the present invention, the step of heating the silicon carbide article includes heating the silicon carbide article within a preferable temperature range of about 600° C. to about 1000° C., and more preferably within a temperature range of about 700° C. to about 900° C. If the article is heated above these temperatures, the silicon carbide will begin to oxide, which is undesirable. Thus, the predetermined temperature is controlled to maintain the temperature below the point where silicon carbide oxidizes.

In all embodiments of the present invention, the step of heating the silicon carbide article includes heating the silicon carbide article in the presence of an oxidizing agent. The oxidizing agent is preferably oxygen or a gas mixture containing oxygen. The oxidizing agent is more preferably selected from the group consisting of air, oxygen, an oxygen-nitrogen gas mixture, an oxygen-argon gas mixture, an oxygen-helium gas mixture, and combinations thereof.

The oxidizing agent can be supplied at various flow rates, depending upon the size of the furnace used to heat treat the silicon carbide articles. For example, a smaller furnace, such as a 1 ft3 furnace, can require a flow rate of about 1 scfh to about 10 scfh. A larger furnace, such as a 4 ft3 furnace, can require a flow rate of about 5 scfh to about 40 scfh. A suitable flow rate for the oxidizing agent will be known to those of ordinary skill in the art of furnaces and is to be considered within the scope of the present invention.

As a result of heating the silicon carbide article, gaseous products are liberated. The gaseous products can include carbon monoxide, carbon dioxide, and combinations thereof. The oxygen contained within the oxidizing agent converts the residual free carbon and graphite to the gaseous products. The residual free carbon and graphite are essentially burned off during the heat-treating process, leaving the silicon carbide article substantially free of carbon and graphite inclusions. As a result of heating the silicon carbide article in the presence of oxygen, the residual carbon and/or graphite oxidizes to form gaseous products as illustrated below by the chemical reactions:
C+½O₂=CO
C+O₂=CO₂

The time period in which the silicon carbide article is heated, predetermined time period, can vary depending on the size of the part and the number of parts that are being heated within the furnace. For example, a single small part, such as a 2″×2″, 1/16″ thick part, can be heated in fifteen minutes and a large lot of larger parts, such as thirty eight inch diameter, ¼″ thick parts, can be heated in up to sixty hours. As an indication that the article is properly heat treated, the article will cease to lose weight once the article is properly heat treated. At this point, the gaseous products will not be emitted from the article. An instrument that is capable of measuring the weight of the article, such as a thermogravimeter apparatus, can be used to help determine when there is no longer a reduction in the weight of the part. Once the article ceases to lose weight, the reduction in the amount of carbon and graphite being removed essentially stops making continued heating of the article unnecessary.

As another embodiment, the present invention advantageously provides a process for heat-treating a silicon carbide article to remove residual amounts of free carbon and graphite from the silicon carbide article. This embodiment preferably includes the step of supplying a silicon carbide article having residual free carbon and graphite abuttingly contacting or adhered to the silicon carbide article. The silicon carbide article is then heated within a temperature range of about 600° C. to about 1000° C. for a predetermined time period in the presence of an oxidizing agent. During the step of heating the silicon carbide article, gaseous products are liberated containing byproducts that are formed by oxidizing the residual free carbon and graphite abuttingly contacting the silicon carbide article. As a result, the residual free carbon and graphite are removed without forming an oxide layer upon the silicon carbide article. The result of this process is that the silicon carbide article is substantially free of carbon and graphite inclusions and ready for subsequent processing without the need for further cleaning.

Another process embodiment of the present invention is advantageously provided. In this embodiment, a silicon carbide article having residual free carbon and graphite abuttingly contacting or adhered to the silicon carbide article is provided. The silicon carbide article is then heated within a preselected temperature range in the presence of an oxidizing agent. The oxidizing agent preferably includes a gas mixture containing oxygen. Gaseous products are liberated during the step of heating the silicon carbide article. The gaseous products advantageously include byproducts formed by oxidizing the residual free carbon and graphite abuttingly contacting the silicon carbide article. The residual free carbon and graphite are removed by this formation of gaseous byproducts without the need to form an oxide layer upon the silicon carbide article. The result is that the silicon carbide article is substantially free of carbon and graphite inclusions.

In addition to the process embodiments described herein, the present invention also advantageously includes a silicon carbide article that is substantially free of carbon and graphite inclusions and without an outer oxide layer abuttingly contacting and substantially surrounding the silicon carbide article. The silicon carbide article is advantageously suitable for use in subsequent plasma etching or other processes. The silicon carbide article is preferably formed by supplying a silicon carbide article having residual free carbon and graphite abuttingly contacting or adhered to the silicon carbide article. The silicon carbide article is then heated within a temperature range of about 600° C. to about 1000° C. in the presence of an oxidizing agent. The oxidizing agent preferably includes a gas mixture containing oxygen. As a result of the heating of the silicon carbide article, gaseous products are liberated that contain byproducts that are formed by oxidizing the residual free carbon and graphite. The byproducts strip away or burn off substantially all of the residual free carbon and graphite without forming an oxide layer upon the silicon carbide article. The resulting the silicon carbide article is substantially free of carbon and graphite inclusions.

As an advantage of the present invention, the present invention can be used to eliminate or reduce the particulate generation counts during plasma etch applications using silicon carbide articles. This advantageous is accomplished by removing the source of the particulates, thereby eliminating the particulate generation problem.

As another advantage of the present invention, the present invention provides a process that is capable of being scaled up for manufacturing for producing a stoichiometric high-purity silicon carbide article. Most processes that are used to produce silicon carbide articles are produced in small, batch processes. The present invention allows for industrial manufacturing of high-purity silicon carbide articles.

1. A process for heat treating a silicon carbide article to remove residual amounts of free carbon and graphite, the process comprising the steps of:
(a) supplying a silicon carbide article having a surface, the surface having residual free carbon and graphite abuttingly contacting the silicon carbide article; and
(b) heating the silicon carbide article within a predetermined temperature range for a predetermined time period in the presence of an oxidizing agent so that gaseous products are liberated containing byproducts formed by oxidizing the residual free carbon and graphite thereby removing the residual free carbon and graphite without forming an oxide layer upon the silicon carbide article so that the silicon carbide article surface is substantially free of carbon and graphite inclusions.

2. The process of claim 1, wherein the predetermined temperature range is between about 600° C. to about 1000° C.

3. The process of claim 2, wherein the predetermined temperature range is between about 700° C. to about 900° C.

4. The process of claim 1, wherein the oxidizing agent comprises a gas mixture containing oxygen.

5. The process of claim 4, wherein the oxidizing agent is selected from the group consisting of air, oxygen, an oxygen-nitrogen gas mixture, an oxygen-argon gas mixture, an oxygen-helium gas mixture, and combinations thereof.

6. The process of claim 1, wherein the gaseous products liberated are selected from the group consisting of carbon monoxide, carbon dioxide, and combinations thereof.

7. The process of claim 1, wherein the predetermined time period is of a length such that there is no longer a reduction in weight of the silicon carbide article and the gaseous products are no longer being liberated.

8. The process of claim 1, wherein the silicon carbide article is selected from the group consisting of converted silicon carbide, reaction-bonded silicon carbide, reaction-formed silicon carbide, chemical-vapor-deposited silicon carbide, and silicon carbide fiber-reinforced silicon carbide matrix composites.

9. A process for heat treating a silicon carbide article to remove residual amounts of free carbon and graphite, the process comprising the steps of:
(a) supplying a silicon carbide article having a surface, the surface having residual free carbon and graphite abuttingly contacting the silicon carbide article; and
(b) heating the silicon carbide article within a temperature range of about 600° C. to about 1000° C. at atmospheric pressure for a predetermined time period in the presence of an oxidizing agent so that gaseous products are liberated containing byproducts formed by oxidizing the free carbon and graphite thereby removing the residual free carbon and graphite without forming an oxide layer upon the silicon carbide article so that the silicon carbide article surface is substantially free of carbon and graphite inclusions.

10. The process of claim 9, wherein the predetermined temperature range is between about 700° C. to about 900° C.

11. The process of claim 9, wherein the oxidizing agent comprises a gas mixture containing oxygen.

12. The process of claim 11, wherein the oxidizing agent is selected from the group consisting of air, oxygen, an oxygen-nitrogen gas mixture, an oxygen-argon gas mixture, an oxygen-helium gas mixture, and combinations thereof.

13. The process of claim 9, wherein the gaseous products liberated are selected from the group consisting of carbon monoxide, carbon dioxide, and combinations thereof.

14. The process of claim 9, wherein the silicon carbide article is selected from the group consisting of converted silicon carbide, reaction-bonded silicon carbide, reaction-formed silicon carbide, chemical-vapor-deposited silicon carbide, and silicon carbide fiber-reinforced silicon carbide matrix composites.

15. The process of claim 10, wherein the predetermined time period in the presence is of a length such that there is no longer a reduction in the weight of the silicon carbide article and gaseous products are no longer being liberated.

16. A process for heat treating a silicon carbide article to remove residual amounts of free carbon and graphite, the process comprising the steps of:
(a) supplying a silicon carbide article having a surface, the surface having residual free carbon and graphite abuttingly contacting the silicon carbide article; and
(b) heating the silicon carbide article within a preselected temperature range at atmospheric pressure for a predetermined time period in the presence of an oxidizing agent comprising a gas mixture containing oxygen so that gaseous products are liberated containing byproducts formed by oxidizing the free carbon and graphite thereby removing the residual free carbon and graphite without forming an oxide layer upon the silicon carbide article so that the silicon carbide article surface is substantially free of carbon and graphite inclusions.

17. The process of claim 16, wherein the predetermined temperature range is between about 600° C. to about 1000° C.

18. The process of claim 17, wherein the predetermined temperature range is between about 700° C. to about 900° C.

19. The process of claim 16, wherein the oxidizing agent is selected from the group consisting of air, oxygen, an oxygen-nitrogen gas mixture, an oxygen-argon gas mixture, an oxygen-helium gas mixture, and combinations thereof.

20. The process of claim 16, wherein the silicon carbide article is selected from the group consisting of converted silicon carbide, reaction-bonded silicon carbide, reaction-formed silicon carbide, chemical-vapor-deposited silicon carbide, and silicon carbide fiber-reinforced silicon carbide matrix composites.

21. The process of claim 16, wherein the preselected time period is of a length such that there is no longer a reduction in the weight of the silicon carbide article and gaseous products are no longer being liberated.

22. A silicon carbide article having a surface substantially free of carbon and graphite inclusions without an outer oxide layer on the surface of the silicon carbide article and being suitable for use in plasma etching, the silicon carbide article being formed by the steps of:
(a) supplying a silicon carbide article having a surface, the surface having residual free carbon and graphite abuttingly contacting the surface; and
(b) heating the silicon carbide article within a temperature range of about 600° C. to about 1000° C. for a predetermined time period in the presence of an oxidizing agent comprising a gas mixture containing oxygen so that gaseous products are liberated containing byproducts formed by oxidizing the residual free carbon and graphite thereby removing the residual free carbon and graphite without forming an oxide layer upon the silicon carbide article so that the silicon carbide article surface is substantially free of carbon and graphite inclusions, the predetermined time period including when there is no longer a reduction in weight of the silicon carbide article surface and the gaseous products are no longer being emitted.
